(19) United States
(12) Patent Application Publication
(10) Pub. No.: US 2024/0030773 A1
(43) Pub. Date: Jan. 25, 2024

(54) ELECTRIC MACHINE FOR DRIVING A MOTOR VEHICLE

(71) Applicant: ZF Friedrichshafen AG, Friedrichshafen (DE)

(72) Inventors: Vyacheslav Brushkivskyy, Kressbronn am Bodensee (DE); Gerhard Höring, Hagnau am Bodensee (DE)

(73) Assignee: ZF Friedrichshafen AG, Friedrichshafen (DE)

(21) Appl. No.: 18/256,268

(22) PCT Filed: Dec. 15, 2021
(86) PCT No.: PCT/EP2021/085922

§ 371 Date: Jun. 7, 2023

(30) Foreign Application Priority Data
Dec. 17, 2020 (DE) 10 2020 216 167.4

(51) Int. Cl. H02K 5/173; H02K 5/15

(52) U.S. Cl. CPC H02K 5/1732; H02K 5/15

(57) ABSTRACT

An electric machine for driving a motor vehicle has a rotor with a rotor shaft (3), an axially fixed bearing, an axially floating bearing (5), a machine housing (7), a securing pin (19) and a protective element (24). The axially fixed bearing is fitted into the electric machine (1) rotationally fixed and not able to move in an axial direction (x) of the electric machine (1), whereas the axially floating bearing (5) is fitted in the machine housing (7) so that it can move in the axial direction (x). The securing pin (19) is designed to prevent an outer ring (10) of the floating bearing (5) from rotating in its circumferential direction (U) relative to the machine housing (7). The protective element (24) is designed to prevent the securing pin (19) from being driven into the machine housing (7) and blocking the floating bearing (5).

### RELATED APPLICATIONS

This application claims the benefit under 35 U.S.C. § 371 as a U.S. National Phase Application of application no. PCT/EP2021/085922, filed on 15 Dec. 2021, which claims benefit of German Patent Application no. 10 2020 216 167.4 filed 17 Dec. 2020, the contents of which are hereby incorporated herein by reference in their entireties.

### FIELD OF THE DISCLOSURE

The invention relates to an electric machine for driving a motor vehicle.

### BACKGROUND

For mounting a rotor shaft in an electric machine designed to drive a motor vehicle, as a rule a fixed bearing and a floating bearing are used. The fixed bearing, in particular an inner ring thereof, is connected permanently to the rotor shaft on one side. On the other side, in particular an outer ring of the fixed bearing is connected fixed to a housing of the electric machine. In contrast, the floating bearing has an axial degree of freedom. Thanks to this mobility of the floating bearing in the axial direction of the electric machine, the rotor shaft can expand when it gets heated or contract when it cools down. As a rule, the floating bearing has an interference fit between the inner ring and the rotor shaft, and a clearance fit between the outer ring and the housing.

### SUMMARY

Drifting of the outer ring in the housing can lead to wear of the housing, particularly if the housing is made of aluminum. This can result in breakdown of the electric machine. Drifting of the outer ring can be prevented, for example, by an interlocking connection between the outer ring and the housing, in particular by means of a pin held in the outer ring of the floating bearing and in a groove inside the housing. However, even with such an interlocking connection, the pin can make its way into the housing and result in blocking of the floating bearing.

A purpose of the present invention can be considered to be to provide a reliable way of mounting a floating bearing in an electric machine, which takes into account the above-described problem. That objective is achieved by embodiments disclosed herein. Advantageous variations and embodiments will be apparent from the description given below and the attached figures.

The present invention proposes to prevent the entry of the pin and the blocking of the floating bearing by means of a protective element in the housing. The protective element can be, for example, in the form of a hardened and bent sheet-metal component.

With this in mind, according to a first aspect of the invention, an electric machine for driving a motor vehicle is provided. The electric machine comprises a rotor with a rotor shaft, an axially fixed bearing, an axially floating bearing, a machine housing, a securing pin, and a protective element. The axially fixed bearing is mounted in the electric machine rotationally fixed and positionally immovably in an axial direction of the electric machine, whereas the axially floating bearing is mounted in such manner that it can move in the axial direction in the housing of the machine. The securing pin is designed to prevent an outer ring of the floating bearing from rotating in its circumferential direction relative to the machine housing. The protective element is designed to prevent the securing pin from being driven into the machine housing and blocking the floating bearing.

So far as the term “rotationally fixed” is concerned, this means that machine elements connected rotationally fixed to one another do not rotate relative to one another. A torque can be transmitted between the said machine elements. In the specific case of the electric machine of the present invention, in particular the outer ring of the floating bearing and the machine housing are connected to one another with interlock in such manner that the outer ring of the floating bearing cannot move in its circumferential direction, or only so to a very limited extent.

The protective element, however, does not restrict axial guiding of the floating bearing. The axial guiding of the floating bearing with the protective element is characterized by a small number and little complexity of components, which results in lower costs of the proposed system. The protective element takes up only little space and can be fitted simply.

According to an embodiment, it is provided that the floating bearing is prevented by an interlocking arrangement from moving in the circumferential direction, whereas in contrast the said interlock allows a movement in the axial direction. In this embodiment the resistance experienced by the floating bearing during a movement in the axial direction can be kept particularly low, for example, if the floating bearing is mounted with a clearance fit or a slightly snug fit, particularly in a bore of the machine housing of the electric machine. With this in mind, according to an embodiment, it is provided that the machine housing forms a guide groove with the protective element arranged between the outer ring of the floating bearing and the said guide groove. The outer ring and the protective element are thus connected with interlock by means of the securing pin in such manner that the outer ring is connected rotationally fixed to the machine housing. Between the securing pin and the protective element there can be some clearance in the circumferential direction. This clearance allows the securing pin to move a short distance in the circumferential direction, for example 1 to 2 mm, before the clearance has been covered, the securing pin encounters the protective element, and the protective element blocks any further movement in the circumferential direction with interlock.

In this connection, a first end of the securing pin can be arranged in a radial bore of the outer ring of the floating bearing, while a second end of the securing pin is held in the guide groove. The securing pin can then be pushed inside the guide groove in the axial direction, while on the other hand it is blocked in the circumferential direction by the protective element.

The protective element can be made of a material that is harder than the machine housing. This contributes toward reducing the risk that the protective element will be damaged by the securing pin when it rotates within the guide groove and encounters the protective element. In particular, the protective element can be made of steel. For example, the protective element can be a bent sheet-steel component.

An axial prestress can be applied to the floating bearing, in particular by a wave spring. For that purpose, the wave spring can exert a force acting on the floating bearing in the axial direction, such that the said force acting in the axial direction can be transmitted to the fixed bearing via the rotor shaft. With this in mind, in a further embodiment, the electric machine comprises a wave spring, a first end of which is supported against the machine housing while a second end of the wave spring is supported against the floating bearing. The wave spring then exerts a spring force on the floating bearing so that the floating bearing and the rotor shaft are pressed in the axial direction toward the fixed bearing.

In this connection the floating bearing can in particular be a grooved ball bearing, which comprises an inner ring and an outer ring, with the wave spring exerting its spring force on the outer ring of the grooved ball bearing. The spring force can be transmitted to the rotor shaft via the inner ring of the grooved ball bearing, so that the rotor shaft together with the grooved ball bearing are pressed in the axial direction toward the fixed bearing, whereby the spring force acts upon the fixed bearing from where it is transferred to the machine housing.

Furthermore, the outer ring of the floating bearing can be fitted into the machine housing with a clearance fit, a slightly snug fit or a slight interference fit.

According to a second aspect of the invention, a drive-train for a utility vehicle is provided, the said drive-train comprising an electric machine according to the first aspect of the invention.

### BRIEF DESCRIPTION OF THE DRAWINGS

Below, example embodiments of the invention are explained in greater detail with reference to the drawings, in which the same or similar elements are denoted by the same index numbers, and which show:

FIG. 1: A rough, schematic, and longitudinally sectioned representation of an electric machine,

FIG. 2: An enlarged, longitudinally sectioned representation of a mounting of a floating bearing for the electric machine in FIG. 1,

FIG. 3: A perspective view of the mounting of the floating bearing in FIG. 2, with a protective element according to the invention,

FIG. 4: A cross-sectional representation of the mounting of the floating bearing in FIG. 2, with the protective element, and

FIG. 5: A cross-sectional representation of the mounting of the floating bearing in FIG. 2, with the protective element.

### DETAILED DESCRIPTION

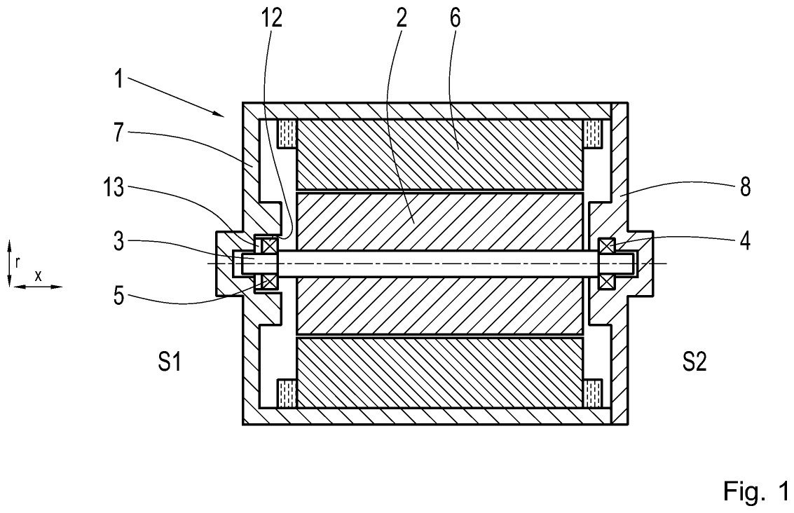

FIG. 1 shows an electric machine 1, in particular an asynchronous machine. The electric machine 1 is used as the central drive (front motor) of a motor vehicle (not shown), for example a utility vehicle, in particular a bus or a truck.

The electric machine 1 comprises a rotor 2 whose rotor shaft 3 is mounted in a fixed bearing 4 and a floating bearing 5. A stator 6 of the electric machine 1 surrounds the rotor 2 in a radial direction r of the electric machine 1. The floating bearing 5 is at a first end side S1 of the electric machine 1. The fixed bearing is at a second end side S2 of the electric machine 1, remote from the first end side S1. The electric machine 1 has a machine housing 7 and a housing cover 8, which closes the electric machine 1 on its second end side S2.

The fixed bearing 4 is a roller bearing with an inner ring and an outer ring (not shown). Between the inner and outer rings, roller bodies are arranged in a known way. The inner ring of the roller bearing 4 arranged radially on the inside is connected rotationally fixed to the rotor shaft 3. The outer ring of the roller bearing 4 arranged radially on the outside is mounted rotationally fixed in the housing cover 8. Furthermore, the outer ring of the roller bearing 4 is fitted in the housing cover 8 in a fixed position in the axial direction x of the electric machine 1. Thus, the roller bearing cannot move to and fro in the axial direction x of the electric machine 1.

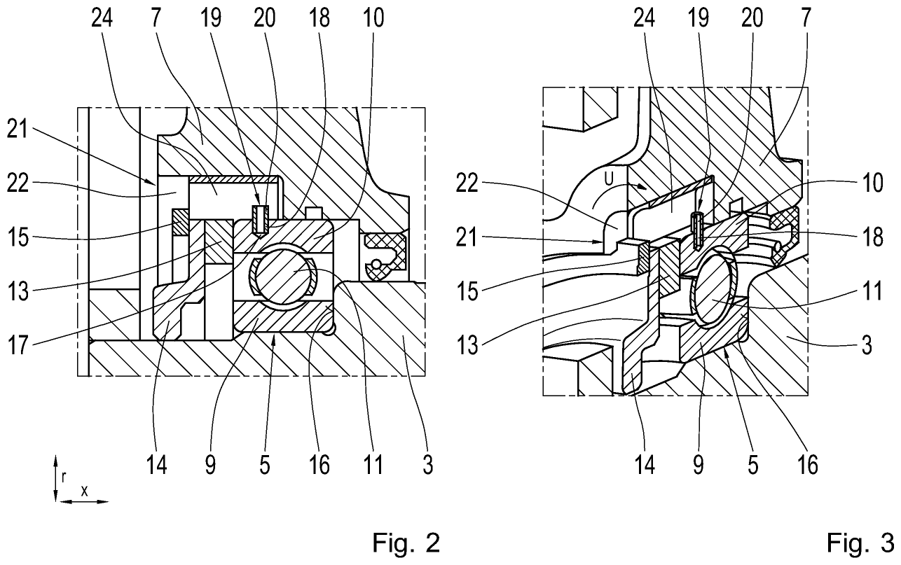

In the example embodiment shown, the floating bearing 5 is a grooved ball bearing. The grooved ball bearing 5 absorbs forces in the radial direction r of the electric machine. The grooved ball bearing 5 comprises an inner ring 9 and an outer ring 10. Between the inner ring 9 and the outer ring 10 are arranged the balls 11 (roller bodies) of the floating bearing 5 (FIGS. 2 to 4). FIG. 1 shows in an exaggerated representation that a fit between the floating bearing and an axial bore 12 of the machine housing 7 is configured such that the floating bearing 5 can move in the axial direction x of the electric machine 1. Thus, there is a clearance fit or a slight transition fit between the floating bearing 5 and the axial bore 12 of the machine housing 7. Accordingly, the floating bearing 5 cannot absorb any forces in the axial direction x, but it is fitted inside the machine housing 7 in such manner that it can be displaced in the axial direction x. The inner ring 9 of the roller bearing 5 is permanently connected to the rotor shaft 3 (FIGS. 2 to 4).

During the operation of the electric machine 1, the rotor shaft 3 in particular warms up and expands in an axial direction x of the electric machine 1. Since the floating bearing 5 is fitted inside the housing 7 so that it can move in the axial direction x, the floating bearing 5 can move in the axial direction x along with the longitudinal expansion of the rotor shaft 3. In the example embodiment shown in FIG. 1 the floating bearing 5 moves to the left when the rotor shaft 3 expands during the operation of the electric machine 1.

A wave spring 13 prestresses the floating bearing 5 in the axial direction x (toward the fixed bearing 4), so that the floating bearing 5 adopts a predetermined position in the axial direction x and so that the balls 11 of the floating bearing 5 can start rolling in a predicted manner. A first axial end of the wave spring 13 is in contact against the outer ring 10 of the floating bearing 5. The second axial end of the wave spring 13 is supported against the machine housing 7 via a pressure plate 14 and a locking ring 15. The wave spring 13 produces a spring force that acts upon the outer ring 10 of the floating bearing 5 in the axial direction x. The spring force is transmitted to the rotor shaft 3 via the inner ring 9 of the floating bearing 5 and via a radial shaft shoulder 16 of the rotor shaft 3, which the spring force transmits to the fixed bearing 4 so that the fixed bearing 4 too is prestressed.

The outer ring 10 of the floating bearing 5 has a radial bore 17 in which a radially inner, first end 18 of a securing pin 19 fits comfortably. A rotation of the outer ring 10 of the floating bearing 5 leads to a corresponding rotation of the securing pin 19. A radially outer, second end 20 of the securing pin 19 is held in a guide groove 21 of the machine housing 7. The guide groove 21 is formed by the machine housing land extends in the axial direction x of the electric machine 1 in such manner that the securing pin 19 can move in the axial direction x of the electric machine 1 so that the expansion of the rotor shaft 3 in the axial direction x of the electric machine 1 is accommodated. During this the floating bearing 5 is displaced in the axial direction x along with the expansion of the rotor shaft 3, and this displacement can take place within axial stop limits defined by the machine housing 7.

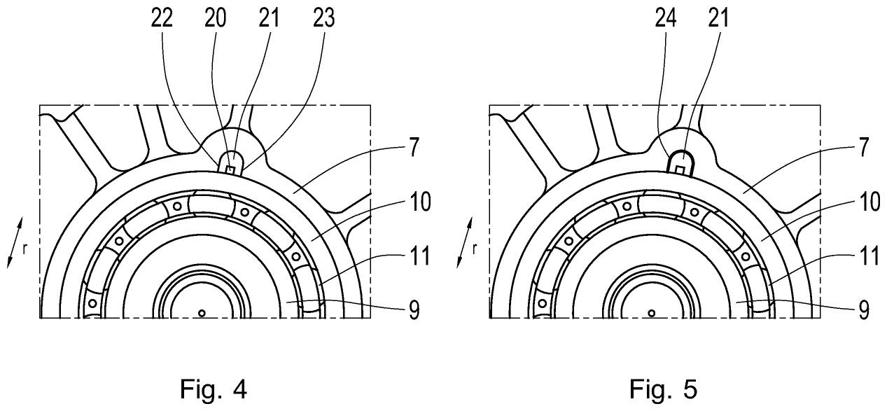

In the radial direction r of the electric machine 1, the restriction of the guide groove 21 blocks a rotation of the securing pin 19 by interlock, and thus also blocks a rotation of the outer ring 10 of the floating bearing 5 in its circumferential direction U. Two delimiting flanks 22, 23 for the guide groove 21, arranged in the circumferential direction U, formed by the machine housing 7 and extending in the radial direction r, allow only a minimal rotation of the outer ring 10 of the floating bearing 5, the maximum permitted rotation being for example of the order of a few millimeters (FIG. 4).

In the example embodiment shown, the machine housing 7 is made of aluminum. This has advantages, particularly in relation to the weight of the electric machine 1. However, it can happen that the second end 20 of the securing pin 19 damages the machine housing 7 in the area of the delimiting flanks 22, 23, owing to the rotation of the outer ring of the floating bearing 5, when the second end 20 of the securing pin 19 encounters the delimiting flanks 22, 23. The result of this can be that the second end 20 of the securing pin 19 is driven into the machine housing 7 in the area of the guide groove 19, whereby the floating bearing 5 can be blocked.

FIGS. 2, 3 and 5 show that a protective element 24 is arranged in the area of the delimiting flanks 22, 23. The protective element 24 is made of a harder material than the machine housing 7. For example, the protective element 24 can be made of steel and can be, for example, a steel sheet. In the example embodiment shown, the protective element 24 has a U-shaped cross-section. This shape can be produced by bending the steel sheet. The protective element 24 covers the delimiting flanks 22, 23 at the points where the second end of the securing pin 19 could be driven into the delimiting flanks 22, 23. In that way the machine housing 7 is protected against damage by the rotating securing pin 19. Thus, at the same time contact between the securing pin 19 and the delimiting flanks 22, 23 of the machine housing 7 is prevented, and so too therefore is blocking of the floating bearing 5. If the protective element 24 is damaged by the securing pin 19, the protective element 24 can be replaced easily.

### INDEXES

r Radial direction
S1 First end side
S2 Second end side
U Circumferential direction
x Axial direction
1 Electric machine
2 Rotor
3 Rotor shaft
4 Fixed bearing
5 Floating bearing
6 Stator
7 Machine housing
8 Housing cover
9 Inner ring
10 Outer ring
11 Ball
12 Axial bore
13 Wave spring
14 Pressure plate
15 Locking ring
16 Radial shaft shoulder
17 Radial bore in the floating bearing
18 First end of the securing pin
19 Securing pin
20 Second end of the securing pin
21 Guide groove
22 Delimiting flank
23 Delimiting flank
24 Protective element

1-10. (canceled)

11. An electric machine (1) for driving a motor vehicle, the electric machine (1) comprising:
a rotor (2) with a rotor shaft (3);
an axially fixed bearing (4);
an axially floating bearing (5);
a machine housing (7);
a securing pin (19); and
a protective element (24);
wherein:
the axially fixed bearing (4) is mounted in the electric machine (1) rotationally fixed, and unable to move in an axial direction (x) of the electric machine (1);
the axially floating bearing (5) is fitted into the machine housing (7) in such manner that it can move in the axial direction (x);
the securing pin (19) is designed to prevent an outer ring (10) of the floating bearing (5) from rotating in its circumferential direction relative to the machine housing (7); and
the protective element (24) is designed to prevent the securing pin (19) from being driven into the machine ox (7) and blocking the floating bearing (5).

12. The electric machine (1) according to claim 11, wherein
the machine housing (7) defines a guide groove;
the protective element (24) is arranged between the outer ring (10) of the floating bearing (5) and the guide groove (21); and
the outer ring (10) and the protective element (24) are connected with interlock by means of the securing pin (19) in such manner that the outer ring (10) is connected rotationally fixed to the machine housing (7).

13. The electric machine (1) according to claim 12, wherein
a first end (18) of the securing pin (19) is arranged in a radial bore (17) of the outer ring (10) of the floating bearing (5);
a second end (20) of the securing pin (19) is held in the guide groove (21); and
the securing pin (19) is configured to be displaced within the guide groove (21) in an axial direction (x) and the securing pin (19) is blocked in the circumferential direction (U) by the protective element (24).

14. The electric machine (1) according to claim 11, wherein the protective element (24) is made of a harder material than the machine housing (7).

15. The electric machine (1) according to claim 14, wherein the protective element (24) comprises a bent sheet component.

16. The electric machine (1) according to claim 14, wherein the protective element (24) is made of steel.

17. The electric machine (1) according to claim 15, wherein the protective element (24) comprises a bent sheet component.

18. The electric machine (1) according to claim 11, comprising a wave spring (13), wherein
a first end of the wave spring (13) is supported against the machine housing (7);
a second end of the wave spring (13) is supported against the floating bearing (5); and
the wave spring (13) exerts a spring force on the floating bearing (5), so that the floating bearing (5) and the rotor shaft (3) are pressed in the axial direction (x) toward the fixed bearing (4).

19. The electric machine (1) according to claim 18, wherein:
the floating bearing is a grooved ball bearing (5) comprising an inner ring (9) and an outer ring (10);
the wave spring (13) exerts a spring force on the outer ring (10) of the grooved ball bearing (5);
the spring force is transmitted by the inner ring (9) of the grooved ball bearing (5) to the rotor shaft (3), so that the rotor shaft (3), together with the grooved ball bearing (5), are pressed in the axial direction (x) toward the fixed bearing (4); and
the spring force acts upon the fixed bearing (4) from where the spring force is transmitted to the machine housing (7).

20. An electric machine (1) according to claim 11, wherein the outer ring (10) of the floating bearing (5) is fitted into the machine housing (7) by one of (i) clearance fit, (ii) a slight transition fit, and (iii) a slight interference fit.

21. A drive-train for a utility vehicle, the drive-train comprising an electric machine (1) according to claim 11.
